(19) United States
(12) Patent Application Publication
(10) Pub. No.: US 2007/0296683 A1
(43) Pub. Date: Dec. 27, 2007

(54) Display device

(75) Inventor: Yukihisa Orisaka, Nabari-shi (JP)

Correspondence Address: HARNESS, DICKEY & PIERCE, P.L.C., P.O. BOX 8910, RESTON, VA, 20195, US

(73) Assignee: Sharp Kabushiki Kaisha

(21) Appl. No.: 11/808,369

(22) Filed: Jun. 8, 2007

(30) Foreign Application Priority Data
Jun. 21, 2006 (JP) 2006-171053

(51) Int. Cl. G09G 3/36

(52) U.S. Cl. 345/100

(57) ABSTRACT

The LCD panel 101 of the present invention includes a panel side wiring 110 that electrically connects mutually adjacent source side drivers 102, 102 and a capacitor 106 connected to the panel side wiring 110. Therefore, by collectively fabricating the capacitor 106 on the LCD panel 101 together with LCD pixels in a step of fabricating the LCD pixels on the LCD panel 101, it becomes unnecessary to mount the capacitor 106 on the source side driver 102, and the cost of the source side driver 102 can be reduced.

### CROSS-REFERENCE TO RELATED APPLICATIONS

This nonprovisional application claims priority under 35 U.S.C. §119(a) on Patent Application No(s). 2006-171053 filed in Japan on Jun. 21, 2006, the entire contents of which are hereby incorporated by reference.

### BACKGROUND OF THE INVENTION

The present invention relates to a display device applied to, for example, an LCD panel.

In general, when a display device is formed by mounting drive semiconductor chips to write display data into an LCD panel, a system for mounting the semiconductor chips onto the LCD panel in a state in which the semiconductor chips are each packaged in a Tape Carrier Package (TCP) or the like and a system for mounting the semiconductor chips directly onto the LCD panel are known. In the case of a large-size panel, the method of mounting the chips onto the LCD panel in the state in which the chips are each packaged in a TCP or the like is mainly adopted.

The above is because a control signal wiring formed on the LCD panel is increased in length although the package cost is saved when the semiconductor chips are mounted directly onto the LCD panel, and the resistance of wiring is high to exert influences on display.

FIG. 7 shows a state in which the drive semiconductors are each mounted onto the LCD panel while being packaged in a TCP or the like. The display device shown in FIG. 7 has an LCD panel 201 to provide a display, a plurality of source side drive semiconductors (hereinafter referred to as source side drivers) 202 to output display data of the LCD panel 201, and a plurality of gate side drive semiconductors (hereinafter referred to as gate side drivers) 203 to control the gates of TFT's (Thin Film Transistors) formed on the LCD panel 201. The plurality of source side drivers 202 are collectively connected to a source side board 204, and the plurality of gate side drivers 203 are collectively connected to a gate side board 205.

Each of the source side drivers 202 receives a control signal inputted from a controller (not shown) via the source side board 204 and outputs a driving signal to the LCD panel 201. On the other hand, each of the gate side drivers 203 receives a control signal inputted from a controller (not shown) via the gate side board 205 and outputs a driving signal to the LCD panel 201. Then, the LCD panel 201 is driven by the driving signal outputted from each of the source side drivers 202 and the driving signal outputted from each of the gate side drivers 203.

Moreover, a method for mounting the chips onto an LCD panel in a state as shown in FIG. 8 is also carried out in order to achieve size reduction, weight reduction and cost reduction by eliminating the source side board 204 and the gate side board 205 of FIG. 7.

The display device shown in FIG. 8 has an LCD panel 201, a plurality of source side drivers 302, and a plurality of gate side drivers 303. The plurality of source side drivers 302 are connected in series and allow a control signal from a controller (not shown) to be inputted to the source side drivers 302 by sequentially transferring the control signal from the controller without using the source side board 204 used in FIG. 7.

Likewise, the plurality of gate side drivers 303 are connected in series and allow a control signal from a controller (not shown) to be inputted to the gate side drivers 303 by sequentially transferring the control signal from the controller without using the gate side board 205 used in FIG. 7.

Then, the LCD panel 201 is driven by the driving signal outputted from the source side drivers 302 to each of which the control signal is inputted and the driving signal outputted from the gate side drivers 303 to each of which the control signal is inputted (refer to JP H06-3684 A and JP 2002-132180 A).

Next, a portion C of FIG. 8, i.e., a connection portion of the source side drivers 302 is shown in FIGS. 9, 10 and 11. Since the connection of the gate side drivers 303 is also similar, only the source side drivers 302 are described.

FIG. 9 is a view showing the connection between the source side drivers 302. In the connection portion, an end portion of one source side driver 302 and an end portion of the other source side driver 302 overlap each other.

The source side drivers 302 are each constructed of a TCP 308 on which the drive semiconductor is mounted, and on the TCP 308 are formed a driver side wiring 109 that is the wiring for receiving and delivering a control signal to the adjacent source side driver 302 and a driving signal wiring 120 that is the wiring for transferring the driving signal outputted from the drive semiconductor chip to the panel. The driver side wiring 109 and the driving signal wiring 120 are formed on the back side of the TCP 308.

Moreover, a capacitor 306 is placed on the driver side wiring 109. The capacitor 306 is placed for the purpose of preventing voltage drop due to the influence of the impedance of the wires and preventing noises of the signal line.

The driver side wiring 109, which is placed on one surface (back surface) of the substrate of the TCP 308, is therefore connected by providing a slit on the substrate of the TCP 308 in order to connect the driver side wiring lines 109 of the source side drivers 302. The state of the connection using the slit is described with reference to FIGS. 10 and 11.

FIG. 10 shows one terminal 302A of one source side driver 302 and the other terminal 302B of the other source side driver 302 before the terminals are connected together. FIG. 11 shows the positional relation of connection between the one terminal 302A of one source side driver 302 and the other terminal 302B of the other source side driver 302.

The one terminal 302A of one source side driver 302 has a slit 307. The slit 307 is formed by making a hole through the TCP 308 and allows the driver side wirings 109 to be mutually continued from the opposite side of the TCP 308. When the one terminal 302A and the other terminal 302B are overlapped as shown in FIG. 11, the driver side wiring 109 of the one terminal 302A and the driver side wiring 109 of the other terminal 302B are connected together via the slit 307.

When an integrated circuit such as an IC is mounted on a board or the like, it is a practice to place a bypass capacitor in the neighborhood of the integrated circuit in order to prevent the voltage drop due to the influence of the impedance of the wires or to place a noise preventing capacitor in order to prevent the noises of the signal line.

In the display device shown in FIG. 7, external components such as a bypass capacitor can be placed on the boards 204, 205. On the other hand, in the display device shown in FIG. 8, a capacitor 306 is placed on the TCP 308 as shown in FIG. 9 since there is nothing corresponding to the boards 204, 205 of FIG. 7.

However, since the capacitor 306 is placed on the TCP 308 in the display device of FIGS. 8 and 9, it is necessary to package the drive semiconductor chip and the capacitor in a same package when the capacitor is placed on the power lines of the source side drivers and gate side drivers or input signal lines, and this has lead to a problem of an increase in the number of manufacturing steps and an increase in the cost.

### SUMMARY OF THE INVENTION

An object of the present invention is to provide a display device capable of reducing the number of manufacturing steps and reducing the cost.

In order to achieve the above object, there is provided a display device in-which
a plurality of driving devices are mounted on a display panel,
at least one signal of mutually adjacent driving devices is connected by way of wiring formed on the display panel, and
the signal is transferred by way of the wiring between the driving devices to provide a display, wherein
a capacitor whose one terminal is connected to a line of the wiring is provided for the display panel, and the capacitor is formed in a step of fabricating the display panel.

According to the display device of the present invention, the capacitor whose one terminal is connected to the wiring is provided for the display panel, and the capacitor is formed in the step of fabricating the display panel. Therefore, the capacitor can be collectively fabricated on the display panel together with pixels and so on in the step of fabricating the pixels of an LCD or the like on the display panel, and this obviates the need for mounting the capacitor onto the driving device itself, allowing the cost of the driving device to be reduced.

In one embodiment of the invention, the capacitor has the other terminal connected to another line of the wiring excluding the wiring line to which the one terminal of the capacitor is connected.

According to the display device of the present embodiment, the other terminal of the capacitor is connected to another line of the wiring excluding the wiring line to which the one terminal of the capacitor is connected. Therefore, the connection of the other terminal of the capacitor is allowed to have a simple construction.

In one embodiment of the invention, the capacitor is connected between a power line of the wiring and a GND line of the wiring.

According to the display device of the present embodiment, the capacitor is connected between the power line of the wiring and the GND line of the wiring. Therefore, the capacitor can be used as a bypass capacitor for preventing the voltage drop due to the influence of the impedance of the wires and so on.

In one embodiment of the invention, the capacitor is connected between the control signal of the wiring and a GND line of the wiring.

According to the display device of the present embodiment, the capacitor is connected between the control signal of the wiring and the GND line of the wiring. Therefore, the capacitor can be used as a noise preventing capacitor for preventing the noises of the control signal.

In one embodiment of the invention, the other terminal of the capacitor is connected to a GND line.

According to the display device of the present embodiment, the other terminal of the capacitor is connected to the GND line. Therefore, the capacitor can be used as a bypass capacitor for preventing the voltage drop due to the influence of the impedance of the wires and so on. Otherwise, the capacitor can be used as a noise preventing capacitor for preventing the noises of the signal line of the wiring.

In one embodiment of the invention, the other terminal of the capacitor is connected to a common electrode formed at the display panel.

In this case, the common electrode means the electrode that faces in common the plurality of electrodes (hereinafter referred to as pixel electrodes) connected to each of the TFT's when the plurality of TFT's are formed on the display panel.

According to the display device of the present embodiment, the other terminal of the capacitor is connected to the common electrode formed at the display panel. Therefore, the capacitor can be used as a bypass capacitor for preventing the voltage drop due to the influence of the impedance of the wires and so on, or the capacitor can be used as a noise preventing capacitor for preventing the noises of the signal line of the wiring.

In one embodiment of the invention, the other terminal of the capacitor is connected to a portion capable of giving an arbitrary voltage.

According to the display device of the present embodiment, the other terminal of the capacitor is connected to a portion capable of giving an arbitrary voltage. Therefore, the capacitor can be used as a bypass capacitor for preventing the voltage drop due to the influence of the impedance of the wires and so on, or the capacitor can be used as a noise preventing capacitor for preventing the noises of the signal line of the wiring.

According to the display device of the present invention, the capacitor whose one terminal is connected to the wiring is provided for the display panel, and the capacitor is formed in the step of fabricating the display panel. This therefore obviates the need for mounting the capacitor onto the driving device and makes it possible to reduce the number of driving device manufacturing steps, allowing the cost to be reduced.

### BRIEF DESCRIPTION OF THE DRAWINGS

The present invention will become more fully understood from the detailed description given hereinbelow and the accompanying drawings which are given by way of illustration only, and thus are not intended to limit the present invention, and wherein:

FIG. 1 is a schematic structural view showing a first embodiment of the display device of the present invention;

FIG. 2 is an enlarged view of a portion A of FIG. 1;

FIG. 3 is a schematic structural view showing a second embodiment of the display device of the present invention;

FIG. 4 is a schematic structural view showing a third embodiment of the display device of the present invention;

FIG. 5 is a schematic structural view showing a modified example of the display device of the present invention;

FIG. 6 is an enlarged view of a portion B of FIG. 5;

FIG. 7 is a schematic structural view showing a conventional display device;

FIG. 8 is a schematic structural view showing another conventional display device;

FIG. 9 is an enlarged view of a portion C of FIG. 8;

FIG. 10 is an explanatory view for explaining the connection portion of FIG. 9; and

FIG. 11 is an explanatory view for explaining the connection portion of FIG. 9.

### DETAILED DESCRIPTION OF THE INVENTION

Hereinbelow, the display device of the present invention will be described in detail in conjunction with the embodiments with reference to the drawings.

### The First Embodiment

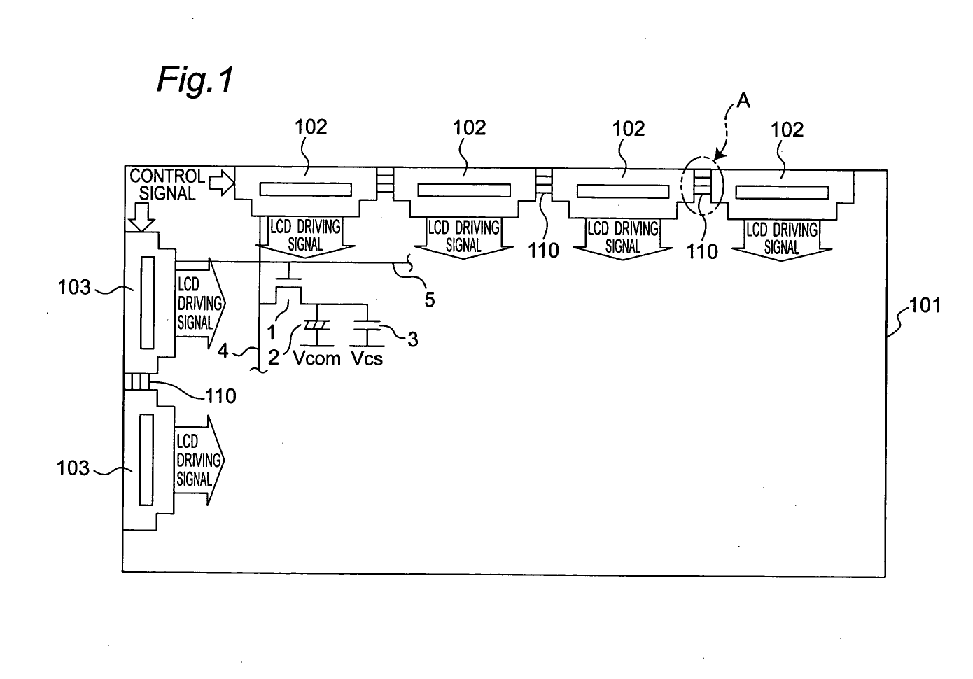

FIG. 1 shows a schematic structural view of the first embodiment of the display device of the present invention. The display device has an LCD panel 101 as a display panel, and a plurality of source side drivers 102 and a plurality of gate side drivers 103 as driving devices.

The plurality of source side drivers 102 are arranged in a straight line along one side of the LCD panel 101. The plurality of gate side drivers 103 are arranged in a straight line along another side that intersects the one side of the LCD panel 101.

The LCD panel 101 includes panel side wiring lines 110, which are placed between mutually adjacent source side drivers 102, 102 and between mutually adjacent gate side drivers 103, 103 to electrically connect the signal lines of the mutually adjacent source side drivers 102, 102 together and connect the signal lines of the mutually adjacent gate side drivers 103, 103 together.

The display device connects the control signals and signals of power sources and so on of the source side drivers 102 and the gate side drivers 103 by way of the panel side wiring lines 110 and transfers the signals among the plurality of source side drivers 102 and the plurality of gate side drivers 103 to provide a display.

The source side drivers 102 output display data of the LCD panel 101, and the gate side drivers 103 control the gates of TFT's (Thin Film Transistors) 1 formed on the LCD panel 101.

In concrete, the plurality of source side drivers 102 receive inputs of a clock signal, gray-scale data, a control signal such as a signal that represents control timing and power via the panel side wiring lines 110. The inputted control signal and power are transferred to the adjacent source side driver 102 by way of wiring lines and buffers provided for the source side drivers 102. As described above, the control signal is inputted while being sequentially transferred, and driving signals are outputted to the LCD panel 101. That is, the control signal is inputted from a controller (not shown) to the source side driver 102 located at the left-hand end and sequentially transferred to the source side driver 102 located on the right-hand side.

On the other hand, the plurality of gate side drivers 103 receive inputs of a clock signal, a control signal such as a signal that represents control timing and power via the panel side wiring lines 110. The inputted control signal and power are transferred to the adjacent gate side driver 103 by way of wiring lines and buffers provided for the gate side drivers 103. As described above, the control signal is inputted while being sequentially transferred, and driving signals are outputted to the LCD panel 101. That is, the control signal is inputted from a controller (not shown) to the gate side driver 103 located at the upper end and sequentially transferred to the gate side driver 103 located on the lower side.

The LCD panel 101 is driven by the driving signals outputted from the source side drivers 102 and driving signals outputted from the gate side drivers 103.

The structure of one LCD pixel of the LCD panel 101 is herein described. The LCD pixel has a TFT 1, a pixel capacitance (capacitor) 2 and an auxiliary capacitance (capacitor) 3.

A gate line 5 that extends from the gate side driver 103 is connected to the gate of the TFT 1, and a source line 4 that extends from the source side driver 102 is connected to the source of the TFT 1.

A pixel electrode is connected to the TFT 1, and a common electrode Vcom is provided facing the pixel electrode. The common electrode Vcom faces in common a plurality of pixel electrodes connected to each of the TFT's 1. Liquid crystals are sealed in between the pixel electrode and the common electrode Vcom, forming the pixel capacitance 2.

Then, the TFT 1 is turned on by a signal from the gate line 5 to apply the voltage of the source line 4 to the pixel capacitance 2. The LCD pixel provides a display by varying the optical transmittance by a voltage difference between the applied voltage and the common electrode Vcom.

The auxiliary capacitance 3 has operation to assist the retention of voltage of the pixel capacitance 2, and the auxiliary capacitance 3 is placed between the drain of the TFT 1 and an electrode Vcs. The electrode Vcs may be in common with the common electrode Vcom or connected to another gate signal or provided with another voltage.

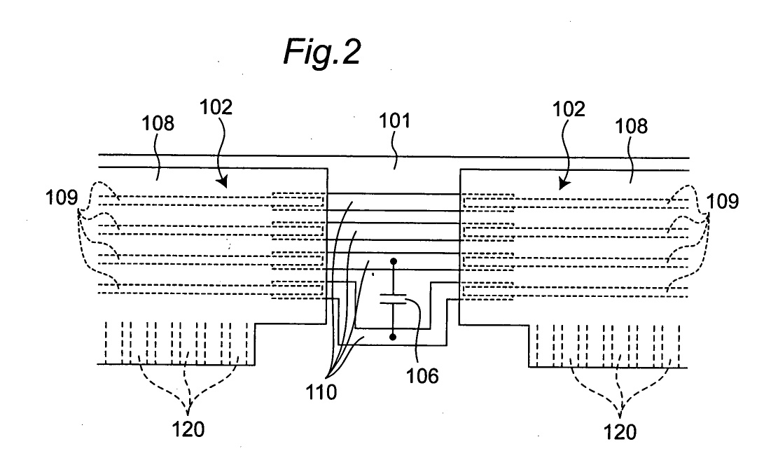

Next, the connection portion of the mutually adjacent source side drivers 102, 102 in a portion A of FIG. 1 is shown in FIG. 2. In the connection portion, an end portion of one source side driver 102 and an end portion of another source side driver 102 overlap the panel side wiring lines 110.

The source side driver 102 is constructed of a TCP (Tape Carrier Package) 108 on which the semiconductor chips are mounted. On the back surface (on the surface located on the LCD panel 101 side) of the TCP 108 are formed driver side wiring lines 109 that are the wiring lines (as signal lines) for receiving and delivering the control signal from and to the adjacent source side driver 102, and driving signal wiring lines 120 that are the wiring lines for transferring the driving signal outputted from the drive semiconductor chip to the LCD panel 101. Then, the mutually adjacent source side drivers 102, 102 have the respective driver side wiring lines 109 connected together via the panel side wiring lines 110.

A capacitor 106 formed in the steps of fabricating the LCD panel 101 is provided for the LCD panel 101. That is, the capacitor 106 is formed of the same construction as that of the auxiliary capacitance 3 shown in FIG. 1 in the same step as that of the auxiliary capacitance 3, the LCD pixels and so on. One terminal of the capacitor 106 is connected to a panel side wiring line 110, and the other terminal of the capacitor 106 is connected to another panel side wiring line 110 excluding the panel side wiring line 110 to which the one terminal of the capacitor 106 is connected. Therefore, the connection of both terminals of the capacitor 106 is allowed to have a simple construction.

In concrete, the capacitor 106 is connected between the power line of the panel side wiring lines 110 and the GND line of the panel side wiring lines 110. That is, the capacitor 106 can be used as a bypass capacitor for preventing the voltage drop due to the influence of the impedance of the panel side wiring lines 110 and so on.

It is noted that the capacitor 106 may be connected between the control signal line of the panel side wiring lines 110 and the GND line of the panel side wiring lines 110, and the capacitor 106 can be used as a noise preventing capacitor for preventing the noises of the control signal line.

It is noted that the connection portion of the mutually adjacent gate side drivers 103, 103 has a construction similar to that of the connection portion of the mutually adjacent source side drivers 102, 102 although not shown.

According to the display device of the above construction, the capacitor 106 connected to the panel side wiring lines 110 is provided for the LCD panel 101, and the capacitor 106 is formed in the step of fabricating the LCD panel 101. Therefore, the capacitor 106 can be collectively formed on the LCD panel 101 together with the LCD pixels in the step of fabricating the LCD pixels on the LCD panel 101. This obviates the need for mounting capacitors on the drivers 102, 103 and allows the cost of the drivers 102, 103 to be reduced.

### The Second Embodiment

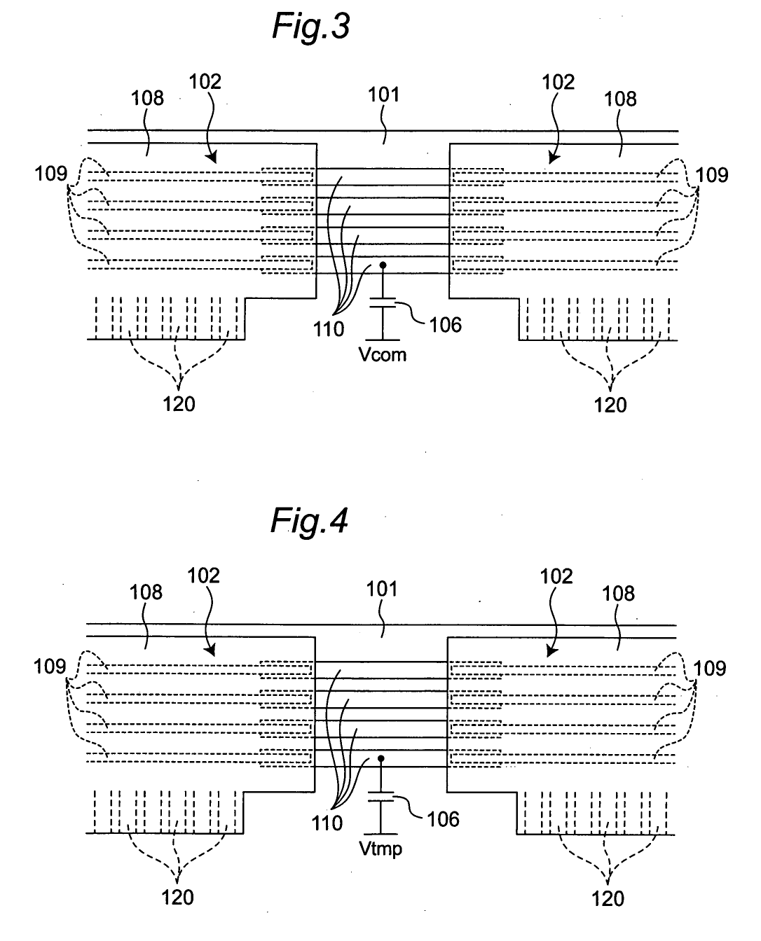

FIG. 3 shows the second embodiment of the display device of the present invention. The present second embodiment differs from the first embodiment (FIG. 2) in that one terminal of the capacitor 106 is connected to a panel side wiring line 110, and the other terminal of the capacitor 106 is connected to the common electrode Vcom formed at the LCD panel 101.

In concrete, the capacitor 106 is connected between the power line of the panel side wiring lines 110 and the common electrode Vcom of the panel side wiring lines 110. That is, the capacitor 106 can be used as a bypass capacitor for preventing the voltage drop due to the influence of the impedance of the panel side wiring lines 110 and so on.

It is noted that the capacitor 106 may be connected between the control signal line of the panel side wiring lines 110 and the common electrode Vcom, and the capacitor 106 can be used as a noise preventing capacitor for preventing the noises of the control signal line.

### The Third Embodiment

FIG. 4 shows the third embodiment of the display device of the present invention. The present third embodiment differs from the first embodiment (FIG. 2) in that one terminal of the capacitor 106 is connected to a panel side wiring line 110, and the other terminal of the capacitor 106 is connected to a portion (prescribed electrode Vtmp in the present embodiment) capable of giving an arbitrary voltage.

In concrete, the capacitor 106 is connected between the power line of the panel side wiring lines 110 and the prescribed electrode Vtmp. That is, the capacitor 106 can be used as a bypass capacitor for preventing the voltage drop due to the influence of the impedance of the panel side wiring lines 110 and so on.

It is noted that the capacitor 106 may be connected between the control signal line of the panel side wiring lines 110 and prescribed electrode Vtmp, and the capacitor 106 can be used as a noise preventing capacitor for preventing the noises of the control signal line.

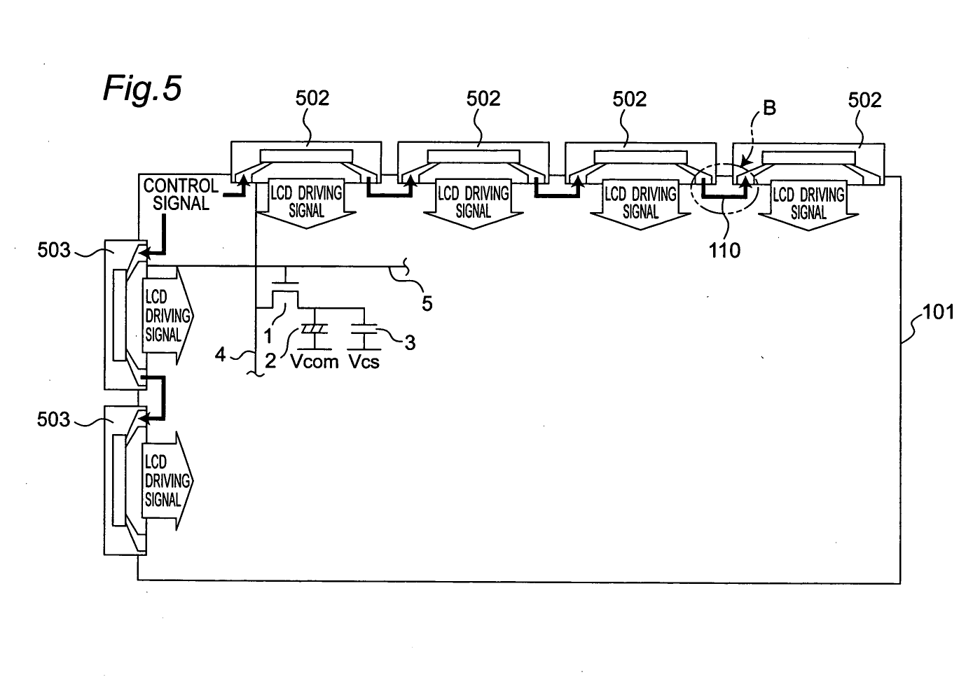

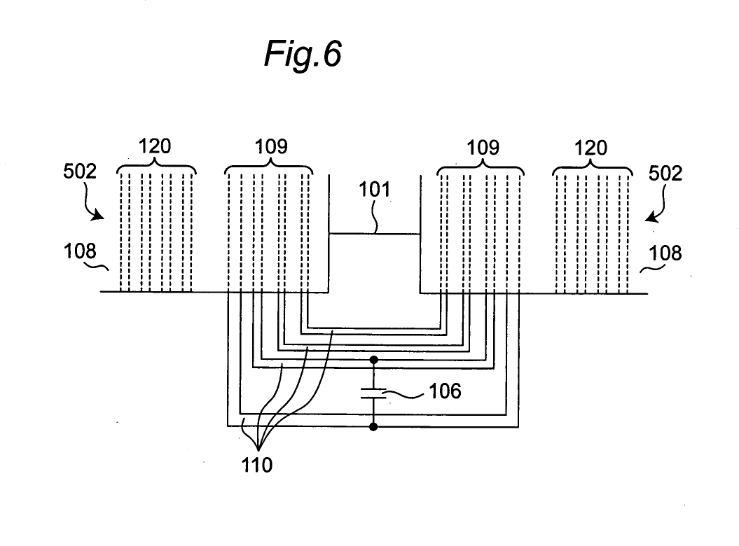

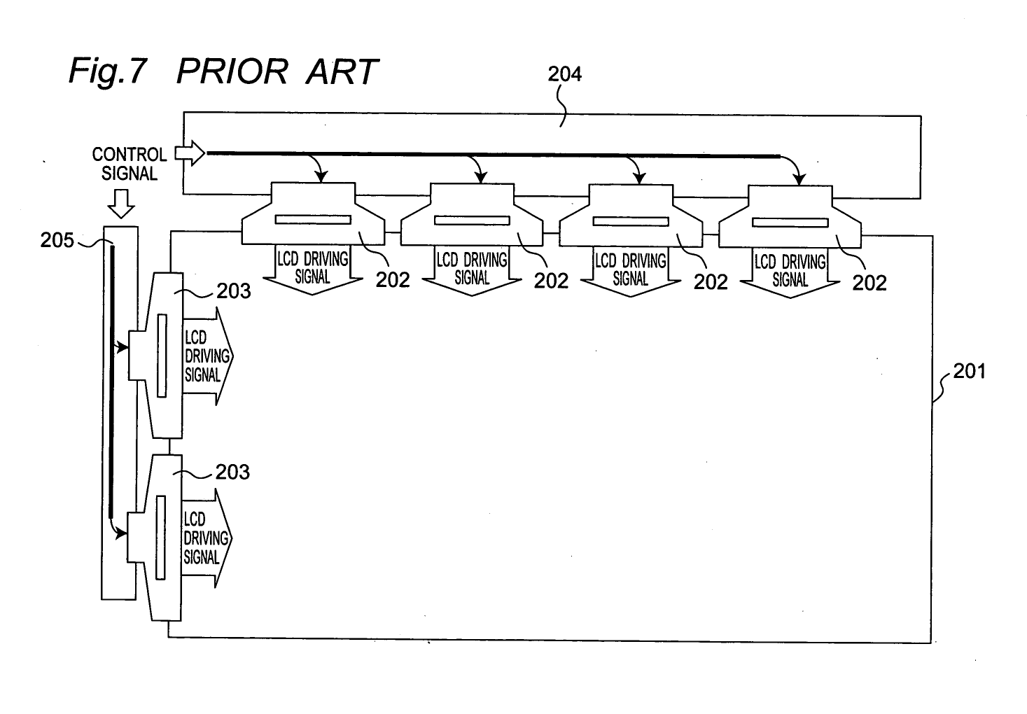

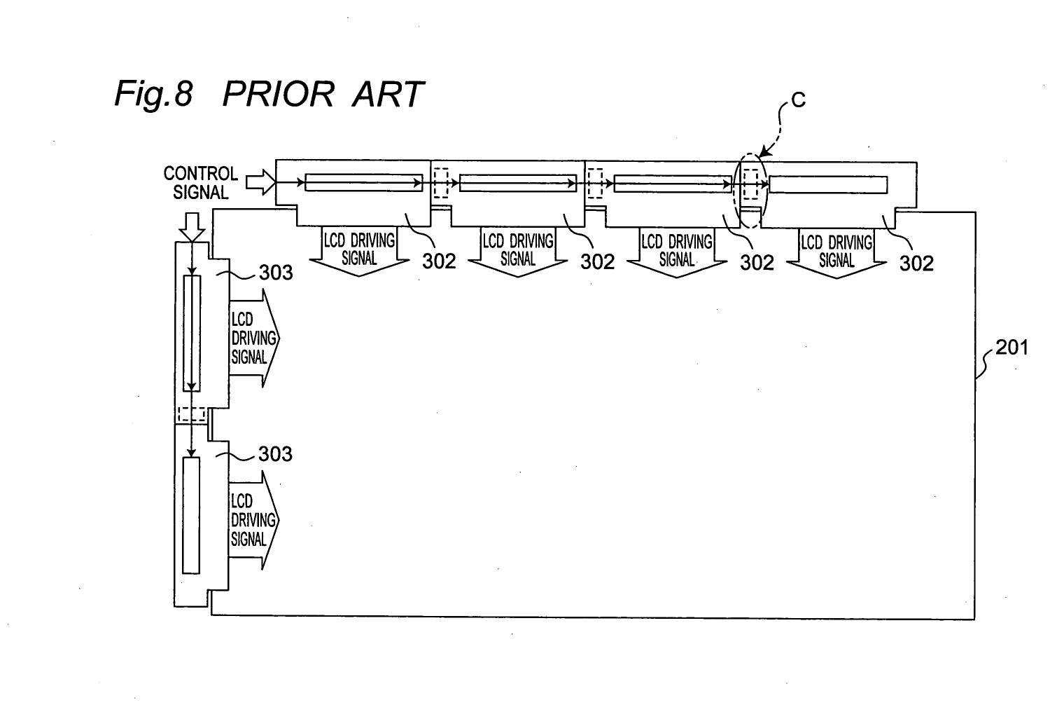

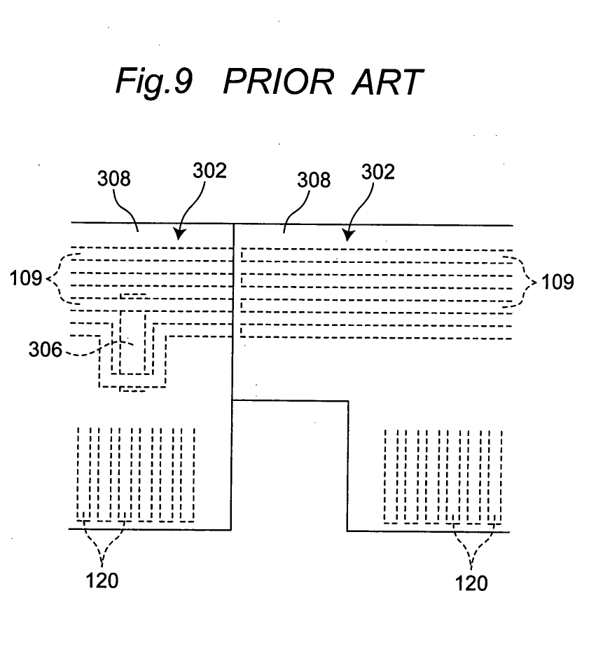

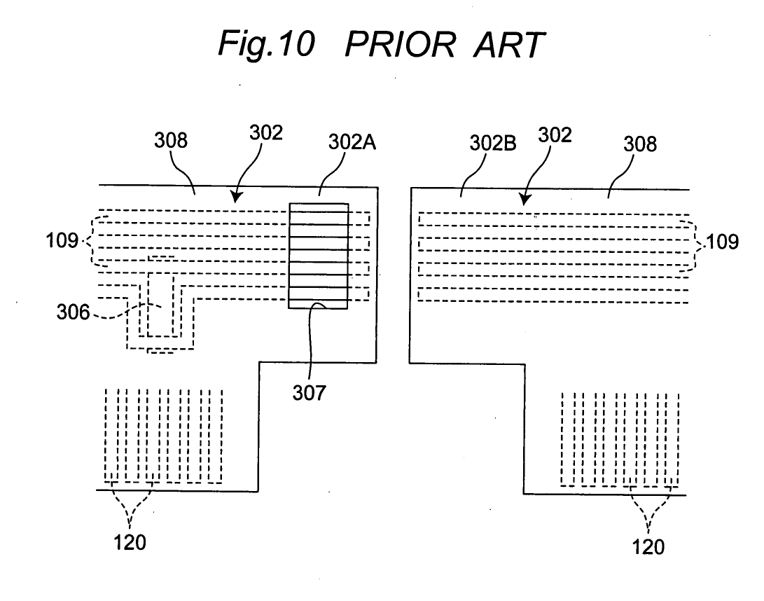

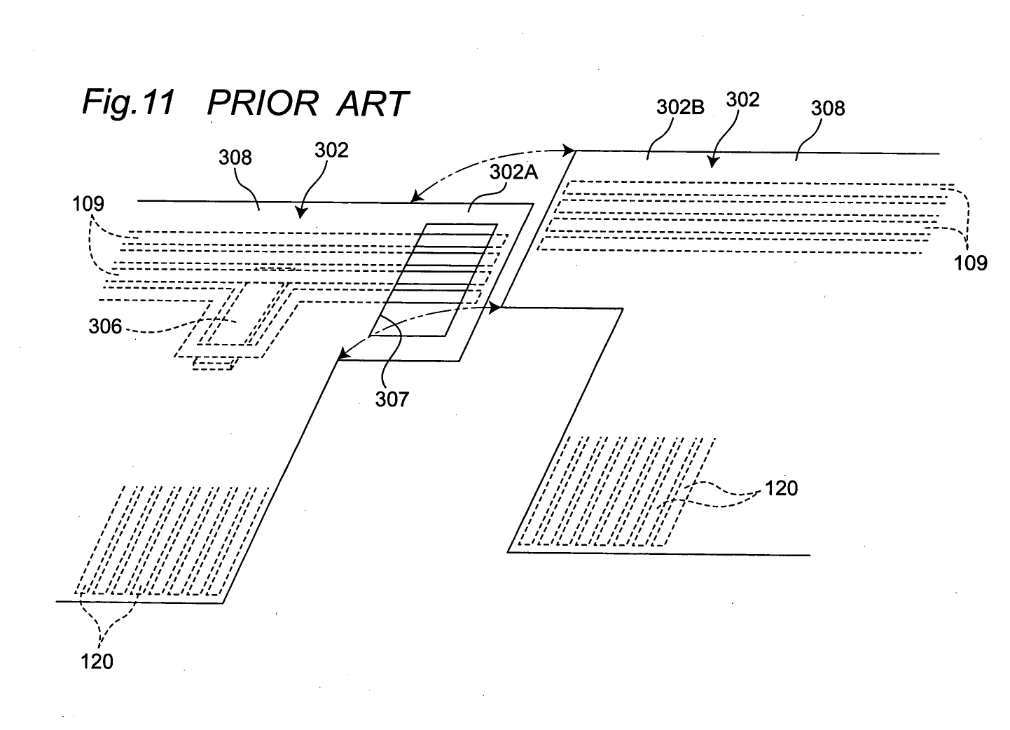

FIGS. 5 and 6 show a modification example of the first, second and third display devices. The modification example differs from the first through third embodiments (FIGS. 1 through 4) in that the driver side wiring 109 that transmits and receives a control signal and the driving signal wiring 120 that transmits a driving signal to the LCD panel 101 are formed on an identical side of a signal wiring surface (corresponding to the back surface in the figure) of the TCP 108 of a source side driver 502. FIG. 6 shows an enlarged view of a portion B of FIG. 5.

With regard to the configurations of FIGS. 1 and 2, the driver side wiring 1.09 that transmits and receives the control signal and the driving signal wiring 120 that transmits the driving signal of the LCD panel are placed along three sides of the TCP 108, and the entire TCP 108 needs to be placed on a glass board (LCD panel 101). However, in the case of the configurations of FIGS. 5 and 6, the frame dimensions of the LCD panel 101 can be narrowed since the parts excluding the terminals of connecting the TCP 108 to the panel can be placed outside the LCD panel 101.

In concrete, an end portion (terminal) of the driver side wiring 109 and an end portion (terminal) of the driving signal wiring 120 are placed along an identical side of the TCP 108. Moreover, the driver side wiring lines 109 of the mutually adjacent source side drivers 502, 502 are connected together via the panel side wiring lines 110.

The capacitor 106 is the capacitor fabricated in a step identical to that of the pixels and so on of the LCD panel 101 shown in FIG. 2 and connected between the power line and the GND line or between the signal line and the GND line as in FIG. 2. It is noted that the capacitor may be placed between Vcom and Vtmp as in FIGS. 3 and 4.

It is noted that the connection portion of the mutually adjacent gate side drivers 503, 503 has a construction similar to that of the connection portion of the mutually adjacent source side drivers 502, 502 although not shown.

The present invention is limited to none of the aforementioned embodiments. For example, the capacitor 106 may be provided so that it is connected to the panel side wiring line 110 between mutually adjacent gate side drivers 503, 503. Moreover, the capacitor 106 may be provided so that it is connected to at least one of all the panel side wiring lines 110.

Embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A display device in which
a plurality of driving devices are mounted on a display panel,
at least one signal of mutually adjacent driving devices is connected by way of wiring formed on the display panel, and
the signal is transferred by way of the wiring between the driving devices to provide a display, wherein
a capacitor whose one terminal is connected to a line of the wiring is provided for the display panel, and the capacitor is formed in a step of fabricating the display panel.

2. The display device as claimed in claim 1, wherein
the capacitor has the other terminal connected to another line of the wiring excluding the wiring line to which the one terminal of the capacitor is connected.

3. The display device as claimed in claim 2, wherein
the capacitor is connected between a power line of the wiring and a GND line of the wiring.

4. The display device as claimed in claim 2, wherein
the capacitor is connected between the control signal of the wiring and a GND line of the wiring.

5. The display device as claimed in claim 1, wherein
the other terminal of the capacitor is connected to a GND line.

6. The display device as claimed in claim 1, wherein
the other terminal of the capacitor is connected to a common electrode formed at the display panel.

7. The display device as claimed in claim 1, wherein
the other terminal of the capacitor is connected to a portion capable of giving an arbitrary voltage.
